(19) United States
(12) Patent Application Publication
(10) Pub. No.: US 2026/0077370 A1
(43) Pub. Date: Mar. 19, 2026

(54) PRODUCT-DISPENSING DEVICE WITH IMPROVED PRIMING AND ASSOCIATED FILLING METHOD

(71) Applicant: GB DEVELOPPEMENT, Vernon (FR)

(72) Inventor: Guillaume BOULAIS, Levallois (FR)

(73) Assignee: GB DEVELOPPEMENT, Vernon (FR)

(21) Appl. No.: 19/106,770

(22) PCT Filed: Aug. 31, 2023
(86) PCT No.: PCT/FR2023/000143

§ 371 Date: Feb. 26, 2025

(30) Foreign Application Priority Data
Aug. 31, 2022 (FR) FR2208743
Nov. 30, 2022 (FR) FR2212602
Aug. 26, 2023 (FR) FR2308969

(51) Int. Cl. B05B 11/00; B65B 3/18

(52) U.S. Cl. CPC B05B 11/0013; B05B 11/0097; B65B 3/18

(57) ABSTRACT

The invention relates to a product dispensing device, comprising: an opening communicating with the outside of the device, a plug, a plug housing; the device being arranged to, at least in the absence of the plug, evacuate fluid and/or gas through the plug housing from a pocket and/or a reservoir of fluid to the opening. The plug housing comprises at least one main part, the plug comprises at least one main part, the main part of the plug housing being arranged to accommodate the main part of the plug, such that in a first insertion position of the plug into the plug housing from the opening, fluid and/or gas can escape from the plug housing through the opening along and/or around the plug, and in a second insertion position of the plug into the plug housing from the opening, for which the plug is further pushed or moved into the plug housing than in the first insertion position, fluid and/or gas can no longer escape from the plug housing through the opening along and/or around the plug.

### TECHNICAL FIELD

The present invention relates to a product dispensing device. It also relates to an associated filling method.

### STATE OF THE ART

Dispensing devices dispensing product or fluid are known.

However, filling these devices according to the state of the art can pose certain priming problems in that it can be difficult to expel a maximum of gas or air when filling it before its first use.

The aim of the present invention is to solve this problem.

### DISCLOSURE OF THE INVENTION

This objective is achieved with a product dispensing device, comprising:
an opening communicating with the outside of the device,
a plug,
a plug housing,
the device being arranged to, at least in the absence of the plug, evacuate fluid and/or gas through the plug housing from a pocket and/or a reservoir of fluid to the opening,
characterized in that:
the plug housing comprises at least one main part,
the plug comprises at least one main part,
the main part of the plug housing being arranged to accommodate the main part of the plug, such that:
in a first position of insertion of the plug into the plug housing from the opening, fluid and/or gas can escape from the plug housing through the opening along and/or around the plug, and
in a second position of insertion of the plug into the plug housing from the opening, for which the plug is further pushed into the plug housing than in the first insertion position, fluid and/or gas can no longer escape from the plug housing through the opening along and/or around the plug.

The main part of the plug housing may comprise a large section and a small section smaller than the large section, the large section being oriented towards the opening and the small section being oriented towards the pocket and/or reservoir.

The main part of the plug may comprise a lateral cavity arranged for the passage of fluid and/or gas along and/or around the plug in the first insertion position of the plug and for a hermetic storage of fluid and/or gas in the second insertion position of the plug.

The lateral cavity may be defined between two sealing rings carried by the main part of the plug.

According to the invention:
the plug housing may comprise following two communicating parts:
   its main part oriented towards the opening
   a thinned part oriented towards the pocket and/or reservoir, the thinned part having a smaller section than the main part of the plug housing.
and/or
the plug may comprise following two communicating parts:
   its main part
   a finger, the finger having a smaller section than the main part of the plug.

Preferably, the finger of the plug may be arranged to be inserted into the thinned part of the plug housing, so that, at least in the first insertion position of the plug, the finger expels fluid and/or gas from the thinned part towards the opening.

According to the invention:
the opening may be an outlet from the device
the main part of the plug may carry a dispensing valve and/or the main part of the plug housing houses a dispensing valve, which in an open state, allows fluid to pass from the inside of the pocket and/or reservoir to the outlet, and, in a closed state, does not allow fluid to pass from the inside of the pocket and/or reservoir to the outlet.

The device according to the invention may comprise the pocket and a dispensing orifice which connects the interior volume of the pocket to the interior volume of a channel.

The pocket may be a deformable pocket having an interior volume arranged to contain the fluid.

The plug housing may comprise clipping or snap-fastening means arranged to hold the plug in its first insertion position.

The device according to the invention may comprise the pocket and the reservoir, and may further comprise a feed orifice which connects the interior volume of the pocket with the interior volume of the reservoir, and a feed valve which, in an open state, allows fluid to pass from the reservoir to the inside of the pocket, and, in a closed state, does not allow fluid to pass from the reservoir to the inside of the pocket.

The device according to the invention may further comprise a vent directly connecting the interior volume of the reservoir to the housing without passing through the pocket. The plug may comprise a vent shutter arranged to close the vent when the plug is in the second insertion position of the plug. The vent shutter may be arranged so as not to close the vent when the plug is in the first insertion position of the plug.

According to yet another aspect of the invention, a method for filling a device according to the invention is provided, in which:
the pocket and/or reservoir are filled with fluid, while the plug is inserted in its first insertion position in the plug housing or is not inserted at all in the plug housing, and:
   fluid and/or gas are caused to rise from the pocket or reservoir towards the opening, preferably by pressing on the pocket and/or reservoir so as to reduce its volume and/or by injecting fluid into the reservoir, and/or
   the plug is pushed or moved in the plug housing so as to move it from its first insertion position to its second insertion position.

According to the invention:
fluid and/or gas may be caused to rise from the pocket or reservoir towards the opening,
then a level of fluid or of the plug may be detected in the plug housing by a sensor, preferably optical or ultrasonic, above a predefined threshold,
then the plug may be pushed or moved in the plug housing so as to move it from its first insertion position to its second insertion position.

According to the invention:
fluid and/or gas may be caused to rise from the pocket or reservoir to the opening, preferably by pressing on the pocket and/or reservoir so as to reduce its volume and/or by injecting fluid into the reservoir, preferably while the plug is not inserted at all into the plug housing,
then a level of fluid in the plug housing may be detected by a sensor, preferably optical or ultrasonic, above a predefined threshold, preferably while the plug is not inserted at all into the plug housing,
then the plug may be pushed or moved in the plug housing so as to move it from the outside of the housing to its first insertion position so that the volume of gas in the housing replaced by the volume of the plug and/or fluid in the housing escapes from the plug housing through the opening along and/or around the plug,
then the plug may be pushed in or moved in the plug housing so as to move it from its first insertion position to its second insertion position.

According to the invention:
fluid and/or gas may be caused to rise from the pocket or reservoir to the opening, preferably by pressing on the pocket and/or reservoir so as to reduce its volume and/or by injecting fluid into the reservoir, while the plug is inserted in its first insertion position in the plug housing, such that the volume of gas in the housing replaced by the volume of the plug and/or fluid in the housing escapes from the plug housing through the opening along and/or around the plug,
then a level of the plug may be detected by a sensor, preferably optical or ultrasonic, above a predefined threshold, while the plug is inserted in its first insertion position in the plug housing,
then the plug may be pushed or moved in the plug housing so as to move it from its first insertion position to its second insertion position.

According to yet another aspect of the invention, there is provided a manufacturing method (possibly combinable with a filling method according to the invention) of a product dispensing device comprising a reservoir with a volume variable by movement of a piston inside walls delimiting, at least in part with the piston, the interior volume of the reservoir, said filling method comprising the following steps:
placing or inserting the piston in the walls at an inlet of the reservoir, so as to maintain a gas passage zone between the piston and the walls; then,
an evacuation of gas from the reservoir to the outside of the product dispensing device through the passage zone; then
an arrival of the piston deeper into the reservoir than when it was positioned at the inlet of the reservoir.

The passage zone may comprise at least one exhaust means formed in the walls on the piston side such as at least one hollow or relief formed in the walls on the piston side and/or by microstructures on at least a portion of the walls in contact with the piston, and/or,
comprises at least one exhaust means on at least a portion of the piston in contact with the walls such as at least one hollow or relief formed in the piston on the wall side and/or microstructures on at least a portion of the piston in contact with the walls,

The passage zone may comprise at least one exhaust means formed in the walls on the piston side only on a limited zone of the walls such that this limitation of the limited zone limits the extent of the air passage zone.

The evacuation may be carried out by suction or depression or by creating a vacuum in a space located outside the product dispensing device by means of a tool.

The tool may comprise a seal which is positioned, during suction or depression or vacuum, on the outer periphery of the inlet of the reservoir from which the piston is flush or partially exceeds.

The arrival of the piston deeper into the reservoir, than when it was positioned at the inlet of the reservoir, may be obtained by pressing, with part of the tool while maintaining suction or depression or vacuum, on the piston.

When the piston arrives deeper into the reservoir than when it was positioned at the inlet of the reservoir, the piston may have exceeded the gas passage zone and so that the gas can no longer pass between the piston and the walls.

The piston may comprise a lip arranged to ensure a seal, against the gas and/or the fluid to be distributed, between the piston and the walls outside the zone.

The piston may comprise another lip, the two lips being oriented towards the inlet of the reservoir through which the piston has been inserted into the reservoir.

The inlet of the reservoir through which the piston has been inserted into the reservoir may be, after insertion of the piston into the reservoir, hidden by a cover.

The cover may be arranged at the inlet of the reservoir simultaneously with the insertion of the piston into the reservoir, a part of the piston receiving this cover by passing through a hole formed in the cover preferably in such a way that this part of the piston is tightened in this hole and thus carries the cover.

According to yet another aspect of the invention, there is provided a product dispensing device comprising a reservoir and a piston, the reservoir being arranged to have a volume variable by movement of the piston inside walls delimiting, at least in part with the piston, the interior volume of the reservoir, said device comprising several positions of the piston inside the walls including:
an inlet position at an inlet of the reservoir, the inlet position of the piston making it possible to maintain a gas passage zone between the piston and the walls,
a deep position which is positioned deeper in the reservoir than when the piston is positioned in its inlet position of the reservoir.

The passage zone may be formed:
by an exhaust element formed in the walls on the piston side and each exhaust element is formed on the walls only on a limited zone of the walls so that this limitation of the limited zone limits the extent of the air passage zone.

The device according to the invention may comprise means arranged to, when the piston has reached its deep position ensuring a seal to the product between the piston and the walls, prevent or limit the return of the piston 52 to the non-sealing zone.

Preferably the device is arranged to prevent a return of the piston into the non-sealing zone under a depression of 0.8 bar relative to atmospheric pressure.

According to yet another aspect of the invention, a product dispensing device is provided comprising:
a pocket connected to a reservoir,
an outlet,
a dispensing valve which, in an open state, allows fluid to pass from the inside of the pocket or reservoir to the outlet, and, in a closed state, does not allow fluid to pass from the inside of the pocket or reservoir to the outlet,
a feed valve which, in an open state, allows fluid to pass from the reservoir to the inside of the pocket, and, in a closed state, does not allow fluid to pass from the reservoir to the inside of the pocket.

The device comprises a valve element arranged to press against an end piece surrounding the outlet so as to block the outlet, the valve element comprises a first part provided with a movable nipple by means of a hinge relative to a second part fixed relative to the end piece or capable only of translating relative to the end piece. The second part being provided with a housing or a spout oriented towards the outlet of the end piece arranged to respectively fit with a spout or a housing of the end piece.

### DESCRIPTION OF THE FIGURES AND EMBODIMENTS

Other advantages and particularities of the invention will appear on reading the detailed description of implementations and embodiments which are not at all limiting, and the following appended drawings:

FIG. 1 is a profile sectional view of a first embodiment of a device according to the invention assembled,

FIG. 2 is a profile sectional view of the first embodiment of a device according to the invention during assembly according to a first embodiment of a filling method according to the invention,

FIG. 3 is a profile sectional view of the first embodiment of a device according to the invention during assembly according to the first embodiment of a filling method according to the invention,

FIG. 4 is a detailed perspective view of the plug of a second embodiment of a device according to the invention, which is the preferred embodiment of the invention,

FIG. 5 is a profile sectional view of the second embodiment of a device according to the invention during assembly according to a second embodiment of a filling method according to the invention,

FIG. 6 is a profile sectional view of the second embodiment of a device according to the invention during assembly according to the second embodiment of a filling method according to the invention,

FIG. 7 is a profile sectional view of the second embodiment of a device according to the invention during assembly according to the second embodiment of a filling method according to the invention,

FIG. 8 is a profile sectional view of a third embodiment of a device according to the invention assembled,

FIG. 9 is a profile sectional view of a fourth embodiment of a device according to the invention assembled,

FIG. 10 is a profile sectional view of the fourth embodiment of a device according to the invention during assembly according to the first embodiment of the filling method according to the invention,

FIG. 11 is a profile sectional view of the fourth embodiment of a device according to the invention during assembly according to the second embodiment of the filling method according to the invention,

FIG. 12 is a profile sectional view of the first embodiment of a device according to the invention during filling with a pipe through the opening,

FIG. 13 is a front view of the first embodiment of a device according to the invention during filling with a pipe through the opening,

FIG. 14 is a perspective view of a fifth embodiment of the device according to the invention during filling with a pipe through the vent 133,

FIG. 15 is a front view of the fifth embodiment of the device according to the invention during filling with a pipe through the vent 133,

FIG. 16a is a front view of the previous devices according to the invention when the plug is separated from the outlet,

FIG. 16b is a front view of the previous devices according to the invention when the plug is separated from the outlet and without the pocket,

FIG. 16c is a zoom of FIGS. 16a and 16b at the plug,

FIG. 17 is a profile sectional view of the reservoir in a variant of the previous devices according to the invention,

FIG. 18a is a perspective of a piston without an exhaust means according to the invention,

FIG. 18b is a perspective of a piston with a microstructure according to the invention,

FIG. 18c is a perspective of a piston with hollows or reliefs according to the invention,

FIG. 19 is a profile sectional view of the piston positioned at the inlet of the reservoir according to the invention,

FIG. 20 is a profile sectional view of the reservoir with an evacuation tool according to the invention,

FIG. 21 is a profile sectional view of the reservoir with a piston pressed in according to the invention,

FIG. 22 is a profile sectional view of the reservoir with a piston provided with a second lip according to the invention,

FIG. 23a is a cross-sectional view of the reservoir provided with hollows or reliefs according to the invention,

FIG. 23b is a cross-sectional view of the non-circular reservoir and the piston according to the invention,

FIG. 24 is a side sectional view of a device 106 with a valve element pressed in according to the invention,

FIG. 25 is a side sectional view of the device 106 with the valve element disengaged according to the invention,

FIG. 26 is a flat sectional view of the device 106 according to another according to the invention,

FIG. 27 is a perspective view of piston 52 illustrating a first variant of means 44 of piston 52,

FIG. 28 is a perspective view illustrating a first variant of means 44 of cover 66,

FIG. 29 is a profile sectional view illustrating the first variant of means 44 of the piston and the cover arranged to, when the piston 52 has reached the sealing zone which is deeper than the zone 65 towards the pocket 2, prevent the return of the piston 52 into the zone 65 of non-sealing of the piston 52,

FIG. 30 is a profile sectional view illustrating the first variant of means 44,

FIG. 31 is a cross-sectional view illustrating the a second variant of means 44,

FIG. 32 is a profile sectional view illustrating the second variant of means 44 arranged to, when the piston 52 has reached the sealing zone which is deeper than the zone 65 towards the pocket 2, prevent the return of the piston 52 into the zone 65 of non-sealing of the piston 52,

FIG. 33 is a profile sectional view illustrating a part of the device comprising this second variant of means 44, as well as the passage 56,

FIG. 34 is a perspective view illustrating a third variant of means 44,

FIG. 35 is a profile sectional view comprising this third variant of the means 44,

FIG. 36 is a profile sectional view of the third variant illustrating in another plane the tabs 45 of the rod 64,

FIG. 37 is a side sectional view of the third variant of the means 44 arranged to, when the piston 52 has reached the sealing zone which is deeper than the zone 65 towards the pocket 2, prevent the return of the piston 52 into the zone 65 of non-sealing of the piston 52.

These embodiments being in no way limiting, variants of the invention may in particular be considered comprising only a selection of characteristics described or illustrated below isolated from the other characteristics described or illustrated (even if this selection is isolated within a sentence including these other features), if this selection of features is sufficient to confer a technical advantage or to differentiate the invention from the state of the prior art. This selection includes at least one preferably functional feature without structural details, and/or with only part of the structural details if only this part is sufficient to confer a technical advantage or to differentiate the invention from the state of the art anterior.

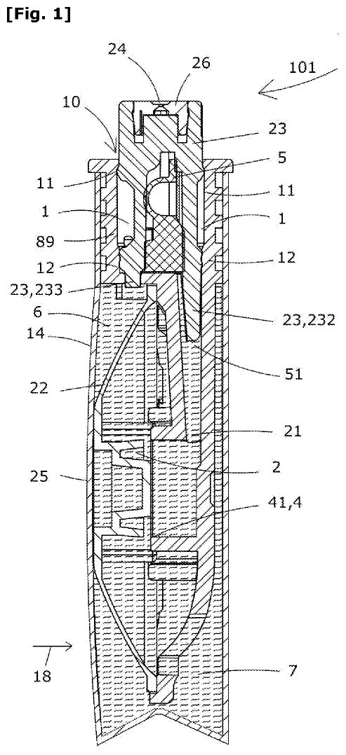

We will first describe, with reference to FIGS. 1 to 3, a first embodiment of device 101 according to the invention and its first embodiment of filling method.

The device 101 comprises:
an opening 10 communicating with the outside of the device 101,
a plug 23,
a plug housing 13.

The device 101 is arranged to, at least in the absence of the plug 23, evacuate the fluid 7 and/or gas through the plug housing 13 from a pocket 2 or a reservoir 6 of fluid 7 to the opening 10.

The fluid 7 is a fluid to be dispensed, preferably comprising a liquid and/or a gel and/or a cream and/or an oil and/or an emulsion.

The gas is preferably air.

The plug housing 13 comprises at least one main part 131.

The plug 23 comprises at least one main part 231.

The main part 131 of the plug housing 13 is arranged to accommodate the main part 231 of the plug 23, such that:
in a first insertion position (illustrated in FIG. 3) of the plug 23 into the plug housing 13 from the opening 10, fluid 7 and/or gas can escape from the plug housing 13 through the opening 10 along and/or around the plug 23, and
in a second insertion position (illustrated in FIG. 1) of the plug 23 into the plug housing 13 from the opening 10, for which the plug 23 is further inserted into the plug housing 13 than in the first insertion position, fluid 7 and/or gas can no longer escape from the plug housing 13 through the opening 10 along and/or around the plug 23.

In the present description, all sections are areas defined in section planes perpendicular to a direction of insertion of the plug 23 into the housing 13.

The main part 131 of the plug housing 13 comprises a large section 141 and a small section 142 smaller than the large section 141, the large section 141 being oriented towards the opening 10 and the small section 142 being oriented towards the pocket 2 or reservoir 6. Preferably the area of the section 141 is at least 3% larger than the area of the section 142, preferably the sections 141 and 142 are cylindrical and the difference between the average diameter of the sections 141 and 142 is at least 0.1 mm.

The main part 231 of the plug 23 comprises a lateral cavity 1 arranged for the passage of fluid 7 and/or gas along and/or around the plug 23 in the first insertion position of the plug 23 and for hermetic storage of fluid 7 and/or gas in the second insertion position of the plug 23.

The volume of the lateral cavity 1 is preferably greater than 10 microliters, preferably greater than 20 microliters or even greater than 30 microliters. The ratio between the volume of the lateral cavity 1 expressed in microliters and the surface area of the large section 141 expressed in mm2 is preferably greater than 0.4, and even preferably greater than 1.

The lateral cavity 1 is defined between two sealing rings or beads 11, 12 carried by the main part 231 of the plug 23.

These two rings 11, 12 are separated by a distance d of at least 2 or 3 mm and/or at least one third of the average diameter of the plug 23 and/or the opening diameter or the largest dimension of the section (perpendicular to its direction of elongation) of the opening 10.

Among these two rings or beads 11 and 12, the ring or beads 12 is arranged to be inserted into the housing 13 before the ring or beads 11.

The plug housing 13 comprises following two communicating parts:
its main part 131 oriented towards the opening 10,
a thinned part 132 oriented towards the pocket 2 or reservoir 6, the thinned part 132 having a smaller section than the main part 131 of the plug housing 13.

The plug 23 comprises following two joined parts:
its main part 231,
a finger 232, the finger 232 having a smaller section than the main part 231 of the plug 23.

The finger 232 of the plug 23 is arranged to be inserted into the thinned part 132 of the plug housing 13, such that, at least in the first insertion position of the plug 23, the finger 232 expels fluid 7 and/or gas from the thinned part 132 towards the opening 10.

The device 101 comprises an outlet 24.

The device 101 comprises a dispensing valve 5 which, in an open state, allows a passage of fluid 7 from the inside of the pocket 2 or reservoir 6 towards the outlet 24, and, in a closed state, does not allow a passage of fluid 7 from the inside of the pocket 2 or reservoir 6 towards the outlet 24.

In the particular case of the device 101, the opening 10 is provided with the outlet 24 of the device when the plug 23 is in its second insertion position.

In the particular case of the device 101, the main part 231 of the plug 23 carries the dispensing valve 5 and/or the main part 131 of the plug housing 13 houses the dispensing valve 5.

The pocket 2 is a deformable pocket having an interior volume arranged to contain the fluid 7.

The reservoir 6 is arranged to contain fluid 7.

The reservoir 6 is also flexible and comprises a flexible wall 14. Thus, the reservoir 6 is arranged to deform by reducing its volume as it empties of fluid 7.

The wall 14 (which forms a bag) is fixed (preferably welded, for example by thermal or ultrasonic welding) to a end piece 89 after having filled the reservoir 6 with product 7, which leaves gas in the reservoir 6 and/or the pocket 2 just after or during welding.

To save time and/or simplify the manufacturing process or device:
this fixing or welding may be carried out at the same time as the pressing on the pocket 2 and/or the reservoir 6 (by the force 18) so as to reduce the volume and cause fluid 7 and/or gas to rise from the pocket 2 or reservoir 6 towards the opening 10 described below, and/or
this fixing or welding may be carried out at the same time, by the same welding means, on two bags of two dispensing devices according to the invention manufactured in parallel.

This end piece 89 is the part that includes the housing 13.

This end piece 89 is the part that includes the bottom wall 21.
The plug housing 13 includes clipping or snap-fastening means arranged to hold the plug 23 in its first insertion position.

The device 101 includes a dispensing orifice 51 that connects the interior volume of the pocket 2 to the interior volume of a channel (this channel being the housing 13 in the particular case of the device 101):
housing the valve 5 (as illustrated in FIG. 1) and/or is closed by a removable cover or removable shutter (case not illustrated), and
ending with the outlet 24 (which may therefore be closed by a removable cover or removable shutter).

The device 101 comprises a feed orifice 41 which connects the interior volume of the pocket 2 to the interior volume of the reservoir 6.

The device 101 comprises a feed valve 4 which, in an open state, allows a passage of fluid 7 from the reservoir 6 to the interior of the pocket 2, and, in a closed state, does not allow (or almost not) a passage of fluid 7 from the reservoir 6 to the interior of the pocket 2 (preferably, this feed valve 4 is not perfectly sealed and may allow a slight backflow in its closed state.).

The deformable pocket 2 comprises:
a deformable or movable wall 22 on which one may press to reduce the interior volume of the pocket, and
a rigid and non-deformable bottom wall 21.

The pocket 2 is arranged to:
when the wall 22 is pressed:
   reduce the interior volume of the pocket 2,
   by overpressure, open the dispensing valve 5 and/or cause fluid 7 to flow out of the pocket 2 towards the outlet 24,
   by overpressure, close the feed valve 4 if present
when the wall 22 is stopped being pressed:
   increase the interior volume of the pocket 2 up to its maximum interior equilibrium volume in the absence of force exerted on the wall 22,
   by vacuum, open the feed valve 4 if present and/or cause fluid 7 to flow out of the reservoir 6 towards the interior volume of the pocket 2,
   by vacuum, close the dispensing valve 5.

The outlet 24 of the device 101 is equipped with a spray nozzle 26.

This nozzle 26 is carried inside the plug 23.

The outlet 24 is located on the vertical axis connecting the pocket to the reservoir.

In other words, the device 101 is arranged so that the fluid 7 exits vertically from the outlet 24.

Furthermore, the device 101 comprises at least one opening or hole or vent 133 connecting the interior volume of the reservoir 6:
either directly to the housing 13 and without passing through the pocket 2,
or outside the device 101 without passing through the housing 13 and without passing through the pocket 2.

FIGS. 1 to 3 describe the particular case of at least one vent 133 (exactly one for the example of these figures) connecting the interior volume of the reservoir 6 either to the housing 13. In this case, the plug 23 comprises, for each vent 133, a vent shutter 233 arranged to close the vent 133 with which it is associated (i.e. not to allow air to pass through this vent 133) when the plug 23 is in the second insertion position of the plug 23 (preferably, each vent shutter 233 is arranged so as not to obstruct the vent 133 with which it is associated when the plug 23 is in the first insertion position of the plug 23).

Still with reference to FIGS. 1 to 3, a first embodiment of the method for filling the device 101 comprises the following steps:
the pocket 2 and/or the reservoir 6 are filled with fluid 7, while the plug 23 is inserted in its first insertion position in the plug housing 13 or is not inserted at all in the plug housing 13 (this filling may be carried out (by a filling pipe or needle 77 or other) either through a vent 133 connecting the reservoir 6 to the housing 13, or through a vent connecting the reservoir 6 to the outside of the device 101 without passing through the housing 13, or through the housing 13 (more precisely through the part 131 and/or 132 of the housing 13) in particular in the absence of a vent 133, or before closing or sealing the reservoir 6 and/or before assembling the reservoir 6 to the end piece 89 or housing 13, then:
   the pocket 2 is pressed so as to reduce its volume and/or the reservoir 6 (in the case of a flexible reservoir, for example in the form of a bag) is pressed so as to reduce its volume and/or (in the case of the existence of at least one vent 133) the fluid 7 is injected either through a vent 133 connecting the reservoir 6 to the housing 13, or through a vent connecting the reservoir 6 to the outside of the device 101 without passing through the housing 13, or through the housing 13 (more precisely through the part 131 and/or 132 of the housing 13) so as to cause fluid 7 and/or gas to rise from the pocket 2 or reservoir 6 towards the opening 10, by exerting a direct or indirect force 18 on the pocket 2 or reservoir 6 or a force 18 caused by a pressure of the fluid 7 for its injection, and/or
   the plug 23 is pushed or moved in the plug housing 13 so as to move it from its first insertion position to its second insertion position.

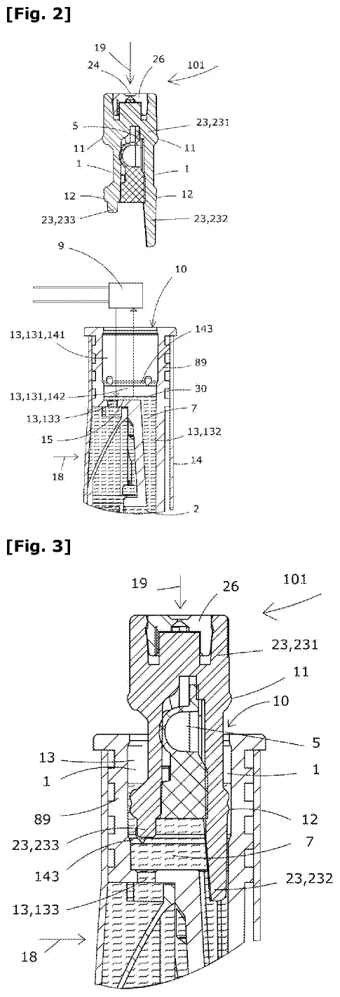

More precisely:
the pocket 2 is pressed so as to reduce its volume and/or the reservoir 6 is pressed (by the force 18) so as to reduce its volume and/or (in the case of the existence of at least one vent 133) the fluid 7 is injected either through a vent 133 connecting the reservoir 6 to the housing 13, or through a vent connecting the reservoir 6 to the outside of the device 101 without passing through the housing 13, or through the housing 13 (more precisely through the part 131 and/or 132 of the housing 13) so as to cause fluid 7 and/or gas to rise from the pocket 2 or reservoir 6 towards the opening 10, preferably while the plug 23 is not at all inserted into the plug housing 13,
the rise of fluid 7 and/or gas of the previous step (i.e. the pressing or the injection of the previous step) is carried out until a level of fluid 7 is detected in the plug housing 13 by a sensor 9 or by eye (the interior of the housing 13 and/or the plug 23 comprising a marking of a level line or a visual level mark), preferably optical or ultrasonic, above a predefined threshold, preferably while the plug 23 is not at all inserted into the plug housing 13; as illustrated in FIG. 2, this threshold is preferably reached when the fluid 7 has completely filled the part 132 and begins to fill the part 131. In practice, the sensor 9 is arranged to detect this threshold by aiming at a surface 15 and by detecting a transformation of this initially bare surface 15 which becomes covered with the fluid 7 coming from the pocket 2 or the reservoir 6; the sensor 9 detects the level of fluid 7 through the opening 10; In another embodiment, the pressing or injection of the previous step is carried out for a determined time corresponding to a certain quantity of fluid 7 and/or gas rising from the pocket 2 or reservoir 6 towards the opening 10 (and it is thus possible to do without a sensor);
then the plug 23 is pushed or moved into the housing 13 (by a force 19 of insertion of the plug 23) of the plug so as to make it pass from the outside of the housing 13 to its first insertion position as illustrated in FIG. 3, so that the volume of gas in the housing 13 is replaced by the volume of the plug 23 (more precisely the volume of the part of the plug 23 which enters the housing of the plug 13) and/or of fluid 7 in the housing 13 and escapes from the plug housing 13 through the opening 10 along and/or around the plug 23,
then, once this threshold is reached and/or detected, the pressure on the pocket 2 or on the reservoir 6 is stopped or the injection of fluid 7 is stopped, and the plug 23 is pushed or moved into the plug housing 13 (by the force 19) so as to make it pass from its first insertion position to its second insertion position as shown in FIG. 1.

The passage of the plug 23 from its first insertion position to its second insertion position comprises a crossing, by the ring or beads 12, of a step or transition 143 separating the large section 141 from the small section 142. When the ring or beads 12 arrives at the level of this step or transition 143, the ring or beads 12 is preferably in contact with the fluid 7.

It is noted that for the first insertion position and for the second insertion position of the plug 23, the finger 232 is at least partially inserted into the thinned part 132, which allows;
a guiding of the plug, and
a rise of the fluid 7 towards the outlet 24 and/or the opening during the passage of the plug from its first insertion position to its second insertion position.

For the first insertion position of the plug 23, the finger 232 is partially inserted into the thinned part 132.

For the second insertion position of the plug 23, the finger 232 is completely inserted into the thinned part 132.

The sensor 9 is preferably an optical sensor and may comprise transmitting-receiving optical fibers or even a camera, but may generally use any suitable technical means (LIDAR, ultrasound, etc.).

In a variant not shown, the pocket 2 and/or the reservoir 6 are filled through the opening 10 from the outside of the device with filling means so as to cause fluid 7 to rise towards the opening 10.

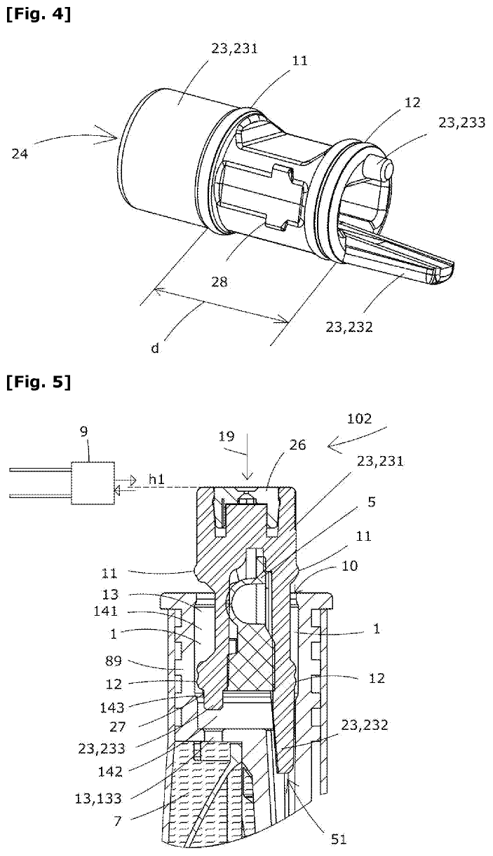

We will now describe, with reference to FIGS. 4 to 7, a second embodiment of the device 102 according to the invention and its second embodiment of the filling method, only for their differences with respect to the first embodiment of the device 101 and method of FIGS. 1 to 3.

The device 102 differs from the device 101 in that it comprises at least one stop 27, 28 on the plug 23 and/or on a wall delimiting the interior volume of the housing 13.

Typically, the device 102 comprises:
a stop 27 (preferably carried by a wall delimiting the interior volume of the housing 13) arranged to prevent the plug from moving from its first insertion position to its second insertion position as long as the force 19 (directed towards the bottom of FIG. 5) is not beyond an insertion force threshold,
a stop 28 (preferably carried by the plug 23, as illustrated in FIG. 4) arranged to prevent the plug 23 from moving from its first insertion position to a position where it is completely out of the housing 13 as long as the force 19 (which this time would be directed towards the top of FIG. 5) is not beyond an extraction force threshold.

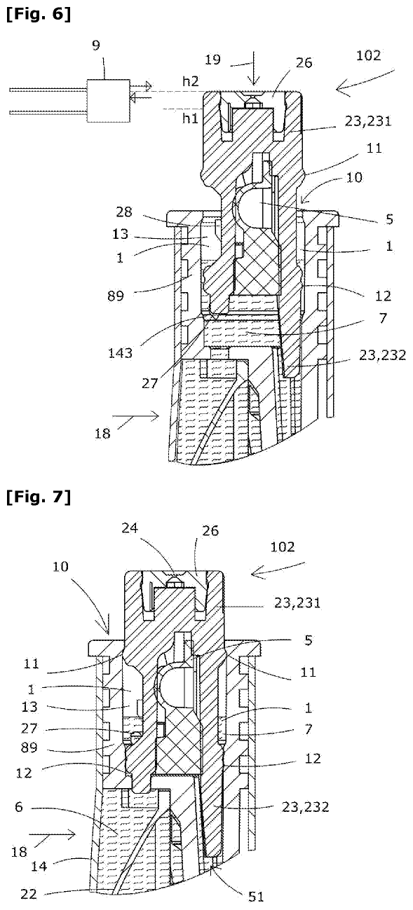

The second embodiment of the filling method according to the invention comprises the following steps:
the plug 23 is inserted into its first insertion position (by the force 19), as illustrated in FIG. 5, the plug 23 being prevented from entering completely into the housing 13 up to its second insertion position by the stop 27 because at this step the force 19 exerted on the plug 23 is less than the insertion force threshold,
then the pocket 2 is pressed so as to reduce its volume and/or the reservoir 6 is pressed (by the force 18) so as to reduce its volume and/or (in the case of the existence of at least one vent 133) the fluid 7 is injected either through a vent 133 connecting the reservoir 6 to the housing 13, or through a vent connecting the reservoir 6 to the outside of the device 101 without passing through the housing 13, or through the housing 13 (more precisely by the part 131 and/or 132 of the housing 13)
so as to cause fluid 7 and/or gas to rise from the pocket or reservoir towards the opening 10, while the plug 23 is inserted in its first insertion position in the plug housing 13, so that the volume of gas in the housing 13 is replaced by the volume of the plug 23 (more precisely the volume of the part of the plug 23 which enters the plug housing 13) and/or fluid 7 in the housing 13 and escapes from the plug housing 13 through the opening 10 along and/or around the plug 23; the upper end of the plug 23 is detected by the sensor 9 or by eye (the interior of the housing 13 and/or the plug 23 comprising a marking of a level line or a visual level mark) as being at a level h1 as illustrated in FIG. 5.
the rise of fluid 7 and/or gas from the previous step (i.e. the pressing or injection of the previous step) is carried out until a level of the plug is detected by the sensor 9 or by eye, preferably optical or ultrasonic, above a predefined threshold h2, while the plug 23 is inserted in its first insertion position in the plug housing 13; as illustrated in FIG. 6, the act of pressing or injecting causes the fluid 7 to rise in the housing 13, which causes the plug 23 to rise from its level h1 to its level h2; the plug 23 is prevented from coming out completely from the housing 13 by the stop 28 because the force exerted by the fluid 7 (Archimedes pressure) on the plug 23 is less than the extraction force threshold,
Then, once the threshold h2 is reached and/or detected, the pressure on the pocket 2 or the reservoir 6 is stopped or the injection of fluid 7 is stopped, and the plug 23 is pushed or moved into the plug housing 13 (by the force 19) so as to make it pass from its first insertion position to its second insertion position, as illustrated in FIG. 7.

In this embodiment, the sensor is preferably an optical sensor and may comprise a transmitting fiber and a receiver, the end of the plug 23 which carries the outlet 24 being placed between the transmitting fiber and the receiver but may generally use any suitable technical means for measuring distance or level (LIDAR, ultrasound, etc.).

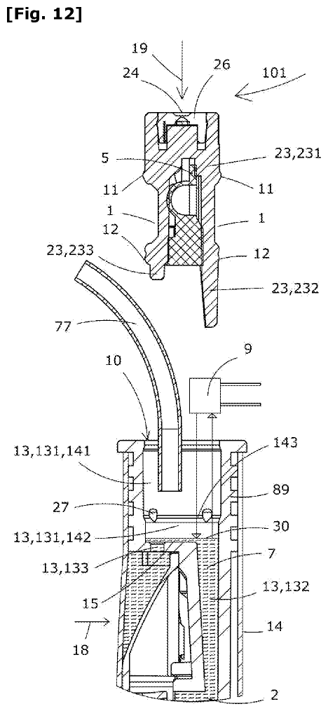

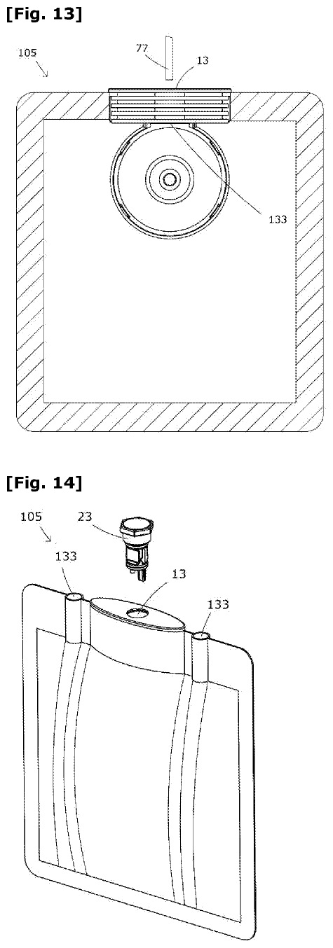

With reference to FIGS. 12 and 13, the wall 14 (which forms a bag) is fixed (preferably welded, for example by thermal or ultrasonic welding), during this step the reservoir 6 is not filled with product.

It is noted that each of the embodiments 101 or 102 previously described may, in an implementation of methods according to the invention, comprise (before and/or during the detection of a fluid level or a level of the plug 23 previously described) a filling of the reservoir 6 with fluid 7 by the pipe 77 through the housing 13:
directly to the reservoir 6 (without passing through the pocket 2) via the at least one vent 133 and/or
preferably to the reservoir 6 passing through the pocket 2 (the vent 133 being optional).

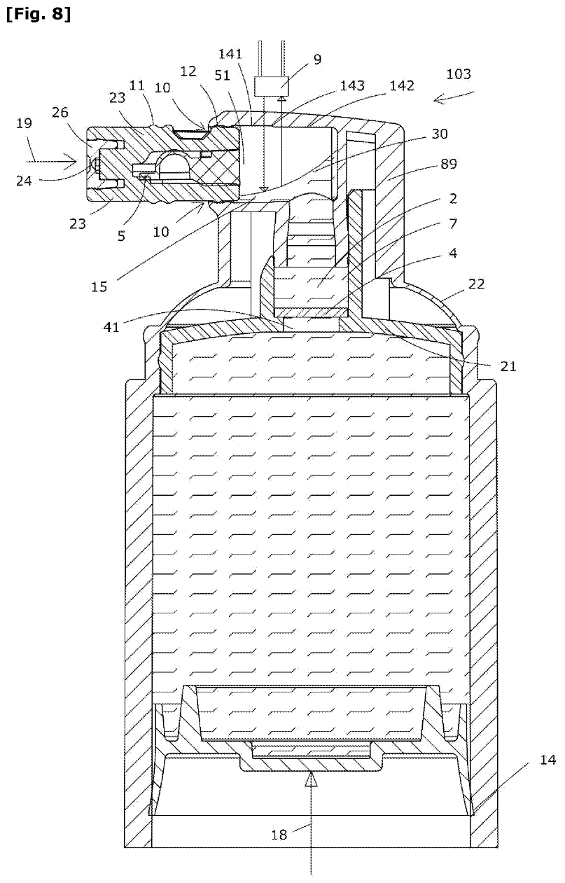

We will now describe, with reference to FIG. 8, a third embodiment of device 103 according to the invention and filling method, only for their differences compared to the first embodiment of device 101 and method of FIGS. 1 to 3.

In this embodiment, the parts 132 and 232 are absent.

The outlet 24 is located laterally relative to a vertical axis connecting the pocket 2 to the reservoir 6.

In other words, the device 103 is arranged so that the fluid 7 exits substantially (to within 20 degrees) horizontally from the outlet 24.

The wall 14 is not flexible and does not form a bag but is a rigid wall in which a piston slides which will reduce the interior volume of the reservoir 6 as the fluid 7 exits the reservoir 6.

The method for filling the device 103 may comprise the same steps as the first embodiment of the filling method described with reference to FIGS. 1 to 3.

However, the sensor 9 detects the level of fluid 7 not through the opening 10, but through the part 89 (also called cap 89 in this embodiment, which forms the internal walls of the housing 13) of the device 103 which is transparent to the radiation used by the sensor 9 so as to make the surface 15 and/or the level 30 of the upper surface of fluid 7 visible by the sensor 9. There is thus preferably, within the same device 103, a part 89 transparent to the radiation used by the sensor 9 and a surface 15 not transparent to the radiation used by the sensor 9.

This principle is also applicable to the naked eye and to a part 89 transparent to radiation of 400 to 700 nm wavelength visible to the naked eye and a surface 15 not transparent to radiation of 400 to 700 nm wavelength visible to the naked eye.

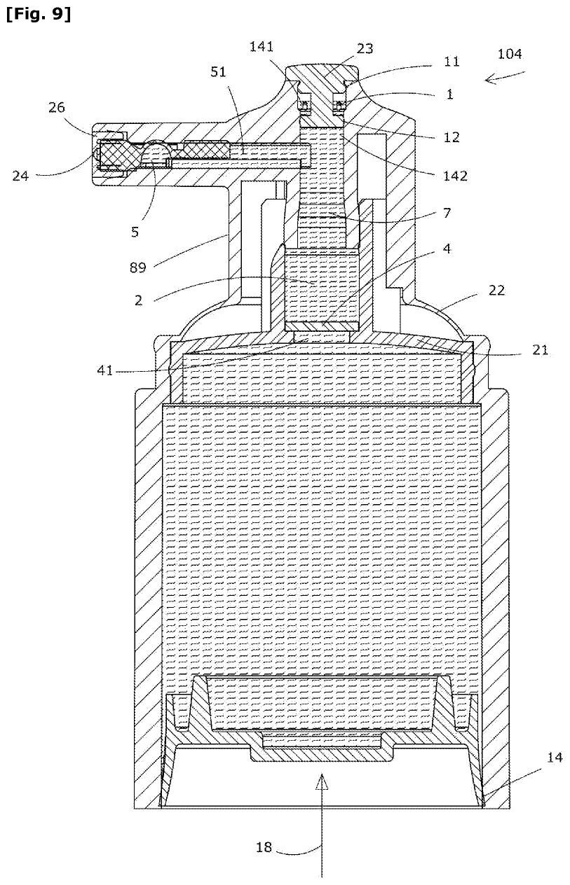

A fourth embodiment of device 104 according to the invention and its filling method will now be described with reference to FIGS. 9 to 11. The device 104 will be described only for its differences from the first embodiment of device 101 of FIGS. 1 to 3.

In this embodiment, the parts 132 and 232 are absent.

The outlet 24 is located laterally relative to a vertical axis connecting the pocket 2 to the reservoir 6.

In other words, the device 104 is arranged so that the fluid 7 exits horizontally from the outlet 24.

In the particular case of the device 104, the opening 10 is distinct from the outlet 24 of the device.

In the particular case of the device 104, the main part 231 of the plug 23 does not carry and does not house the dispensing valve 5.

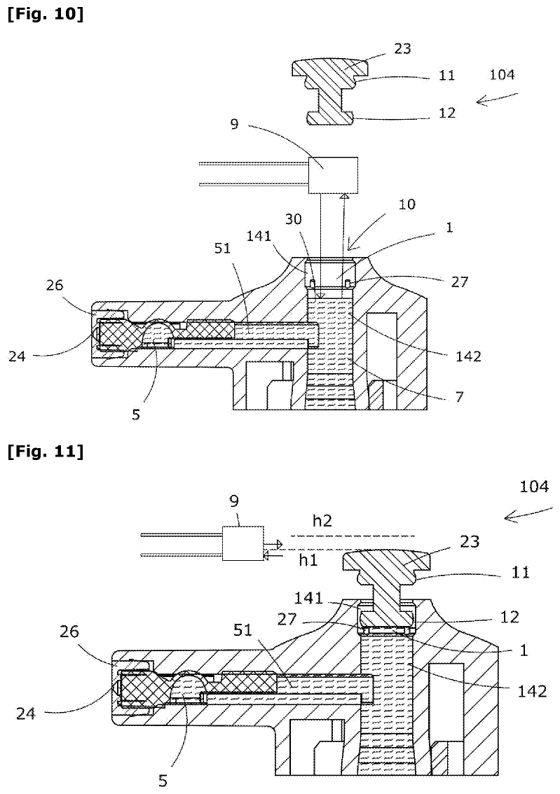

The method of filling the device 104 may comprise;
as illustrated in FIG. 10, the same steps as the first embodiment of the filling method described with reference to FIGS. 1 to 3; we note,
as illustrated in FIG. 11, the same steps as the second embodiment of the filling method described with reference to FIGS. 4 to 7.

We will now describe, with reference to FIGS. 14 and 15, a fifth embodiment of device 105 according to the invention and filling method, only for their differences compared to the first embodiment of device 101 and method of FIGS. 1 to 3.

In this embodiment 105, the at least one vent 133 comprises several vents 133.

Each vent 133 connects the interior volume of the reservoir 6 to the exterior of the device 101 [sic] without passing through the housing 13 and without passing through the pocket 2.

Each vent 133 is typically formed on a periphery of the walls 14 delimiting the interior volume of the reservoir 6, and typically corresponds to a non-welded zone of two welded films or walls forming a bag.

In a sectional view passing through the reservoir 6, the pocket 2, the housing 13 and each (or the) vent 133, each (or the) vent 133 is located on the same side as the housing 13 relative to the interior volume of the reservoir 6.

The implementation of the method according to the invention comprises (before and/or during the detection of a fluid level or a level of the plug 23 previously described) a filling of the reservoir 6 with fluid 7 by the pipe 77 via at least one vent 133 connecting the interior volume of the reservoir 6 directly to the housing 13 and without passing through the pocket 2.

It is further noted that the fifth embodiment of the device 105 comprises openings 42 and 43 on the wall 22, allowing air or gas to pass through these openings 42, 43 between on the one hand the volume delimited inside the wall 22 and on the other hand the remainder of the pocket 2 or of the reservoir 6 when filling the reservoir 6 with the fluid 7 by means of the pipe 77 or by any other method (for example by immersing the wall 22 in the reservoir 6 filled with fluid 7).

These openings 42, 43 comprise:
at least one upper opening 42 positioned as high as possible on the wall 22 relative to the position of the wall 22 during filling, preferably positioned on the wall 22 on the side of the plug 23 and/or a vent 133, and
at least one lower opening 43 preferably positioned on the wall 22 opposite the plug 23 and/or this same vent 133.

These openings 42, 43 make it possible to remove (preferably completely) air or gas from the interior volume of the wall 22 by expelling this air or gas by a flow (typically of fluid 7) guided from one opening 43 to another 42, and therefore prevent the formation of air or gas bubbles in this interior volume of the wall 22.

These openings 42, 43 are also present in the first embodiment of device 101, even if they are not visible in the figures of this embodiment 101 because these figures do not include a front view.

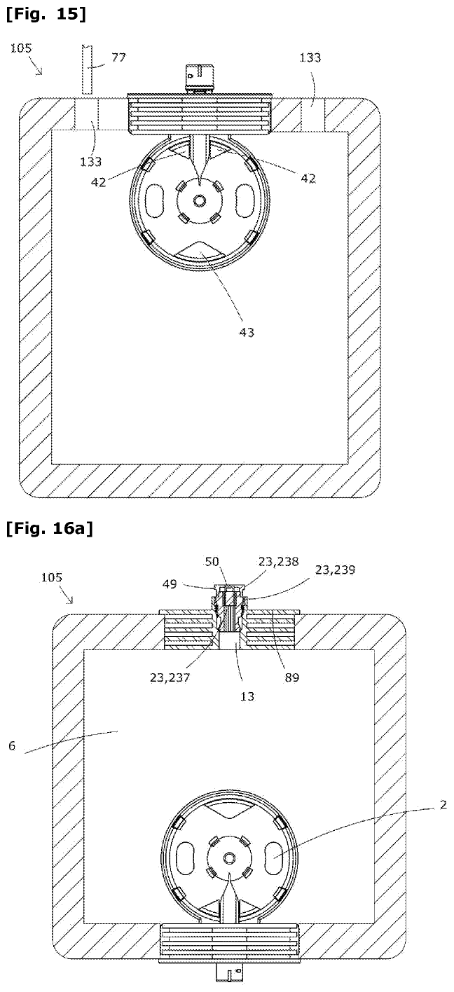

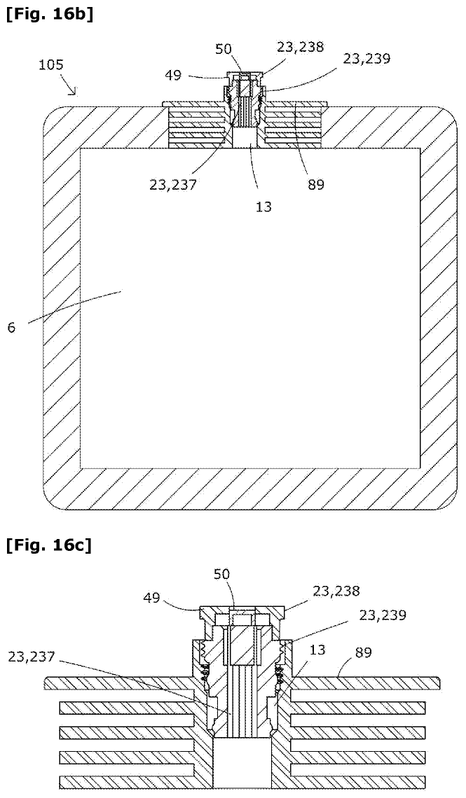

In all of the embodiments 101, 102, 103, 104, 105 previously described:
i) each vent 133 thus makes it possible to evacuate air when filling the reservoir with the fluid 7 and thus prevents an accumulation of air in a zone located around and/or above the pocket, when the device according to the invention is oriented with its housing 13 positioned above the pocket 2, and/or
ii) with reference to FIG. 16a, the plug 23 and its housing 13 may be separated from the outlet 24 and the valve 5; in other words, fluid can pass from the interior volume of the reservoir 6 to the outlet 24 and/or the valve 5 without passing through the plug 23 and/or the housing 13, and/or
iii) with reference to FIGS. 16b and 16c, a variant of the device 101, 102, 103, 104 or 105 may not include a pocket 2 and/or a valve 5,

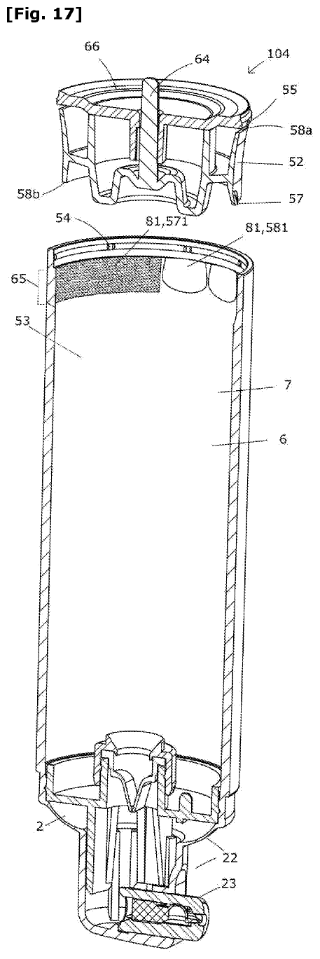

The reservoir 6 is refillable with product 7, the plug 23 being removable from the end piece 89 by screwing means 239. The plug 23 comprises a refill valve or a cover 50 (blocking the channel 237 which passes through the plug 23) fixed with the closing part 49 preventing the product from escaping when it is not connected with the connection means 238 of the plug, and/or,
iv) With reference to FIGS. 17 to 23b and 27 to 37, a variant of the device 101, 102, 103, 104 or 105 may have its reservoir 6 with a volume variable by movement of a piston 52 inside walls 53 delimiting (at least in part with the piston 52) the interior volume of the reservoir 6.

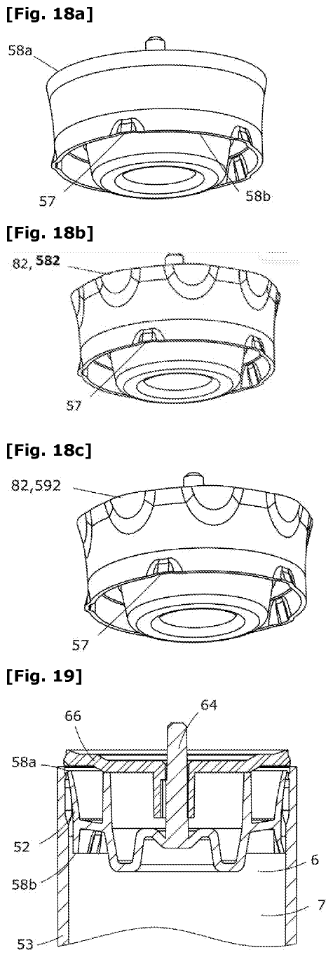

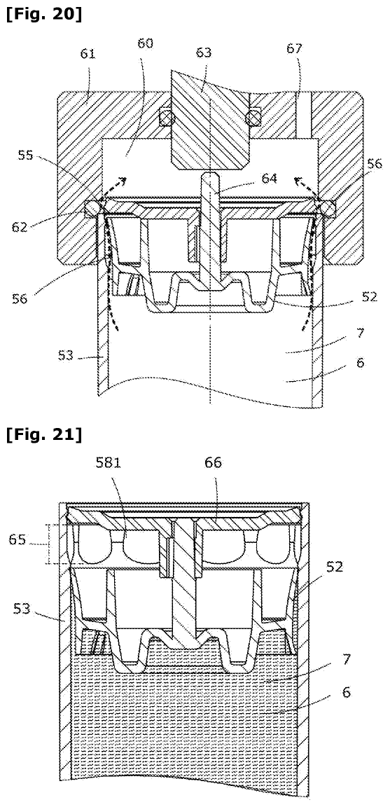

Concerning point iv) above, an embodiment of the method for manufacturing a product dispensing device according to the invention may comprise (possibly in combination with the filling method previously described) the following steps:
the piston 52 is placed or inserted in its inlet position in the walls 53 at the inlet of the reservoir 6, as illustrated in FIG. 19, so as to maintain a zone 56 for the passage of gas or air between the piston 52 and the walls 53 by at least one hollow or relief 55 formed in the cover 66 and/or a hollow or relief 54 at the inlet of the reservoir 6 at the level of the fitting of the bottom 66 and/or exhaust means 81 formed in the walls 53 on the piston side and/or exhaust means 82 formed in the piston (more precisely at the level of the lower lip 58a) described below.
Then, gas is evacuated from the reservoir 6 to the outside of the product dispensing device via the zone 56, as illustrated in FIG. 20; this evacuation 67 may be carried out by suction or depression or by creating a vacuum (preferably a depression of at least 0.5 bar relative to atmospheric pressure) in a space 60 located outside the product dispensing device by means of a tool 61. The tool 61 comprises a seal 62 which is positioned, during the suction or depression or the vacuum on the outer periphery of the inlet of the reservoir 6 from which the piston 52 is flush or partially exceeds.
It should be noted, however, that this suction or depression or vacuum is not always necessary, this evacuation may also be carried out by pressing on the piston 52 to push it towards the inside of the reservoir 6 so as to expel the air or gas through the passage zone 56 (therefore without suction 67);
this gas passage zone 56 may be formed for example by at least one exhaust means 81 formed in the walls 53 on the side of the piston 52 such as:
a hollow or relief 581 at least on a portion of the walls 53 on the side of (i.e. oriented towards) the piston 52 (as illustrated in FIGS. 17 and 23a) in contact with the piston,
microstructures 571 (preferably comprising a roughening or microgrooves) (as illustrated in FIG. 17) on at least a portion of the walls 53 in contact with the piston,
a non-circular shape 591 of the walls 53 on the side of the piston 52 in a cross-section plane to the axis of movement of the piston 52 along the walls 53 as illustrated in FIG. 23b where an oval shape is noted,
and/or by at least one exhaust means 82 on at least a portion of the piston 52 in contact with the walls 53 more precisely at a lower lip 58a (the lip oriented towards the bottom of the device closest to the inlet of the reservoir 6 by which the piston 52 has been inserted into the reservoir 6) such as:
a hollow or relief 582 formed in the piston 52 on the side of the walls 53 more precisely formed in at least one lip 58a of the piston 52 (as illustrated in FIG. 18c) typically of a size greater than 1 mm,
microstructures 572 (preferably comprising a frosting or microgrooves typically of a size less than 150 μm) (as illustrated in FIG. 18b) formed in at least one lip 58a of the piston 52,
a non-circular shape of one lip 58a of the piston 52 (typically a circularity deviation of more than 300 μm),
then an arrival of the piston 52 (in its deep position) deeper in the reservoir 6 than when it was positioned at the inlet of the reservoir 6, so that at least one lip of the piston 52 has passed the zone 56, as illustrated in FIG. 21, and that the gas can no longer pass between the piston 52 and the walls 53 on at least one lip 58a or 58b, the piston 52 being provided with at least one lip arranged to ensure a seal to the fluid 7 between the piston 52 and the walls 53 outside the zone 56. For this, it is possible to press (for example with a part 63 of the tool 61 while maintaining the suction or the depression or the vacuum) on a rod 64 secured to a bottom 66 of the piston 52.

It should be noted that in the case of exhaust means 82, the zone 56 moves with the piston 52 and is therefore never passed by the piston. Unlike the hollows and reliefs 54 at the inlet of the reservoir 6, the exhaust means 81 and 82 are arranged to ensure, by their size, that gas or air can pass between the piston 52 and the walls 53 but not to let the fluid 7 pass or to let very little fluid 7 (liquid, gel, cream, etc.) pass between the piston 52 and the walls 53 at least over a deep zone at the end of the depression of the piston 52, so that when the piston 52 sinks sufficiently into the reservoir 6 until it comes into contact with the fluid 7 to be dispensed, at least one junction (at least one lip) between the piston 52 and the walls 53 becomes sealed or almost sealed against the fluid 7. Preferably, the passage zone 56 comprises at least one exhaust means 81 formed in the walls 53 on the piston side and each exhaust element 81 is formed on the walls 53 only over a limited spatial zone 65 of the walls 53 so that this limitation of the limited zone limits the spatial extent of the air passage zone 56. In this case it is preferable that the piston 52 does not include an exhaust means 82, at least one lip of the piston 52 in contact with the walls 53 of the reservoir 6 is smooth and circular (as illustrated in FIG. 18a) and is airtight even to air or gas beyond the zone 65 (towards the pocket 2). By gas-tightness or air-tightness by the piston 52, it is meant a minimum seal allowing a leak of less than 0.05 cm³/s of air with a pressure difference between the inside of the reservoir and the outside of the device of 0.2 bar at 20° C. (the orifice 41 being plugged). The reservoir being filled with air or gas, the piston is not sealed in the zone 65 but is sealed in a zone deeper than the zone 65 towards the pocket 2, this thanks to the exhaust means 81 limited in the depth of the reservoir 6. Typically the height 65 of the exhaust means 81 from the inlet of the reservoir is less than 20 mm but this height may be more for example in the case where one wants with the same reservoir height to have different capacities, in this case only one part of the mold forming the reservoir (the core) is modified.

With reference to FIG. 18a, it is noted that the piston comprises, opposite the wall 58a, a wall 58b provided with bumps 57 arranged to guide the piston by forming a passage zone 56. The air and the product may pass between the bumps when the piston 52 is pushed in. In a variant not shown, the piston 52 comprises a lower lip 58a and an upper lip 58b which are sealed (i.e. without exhaust means 82), in the pushed-in position of the piston, a lip 58a or two lips 58a and 58b may be airtight beyond the zone 65.

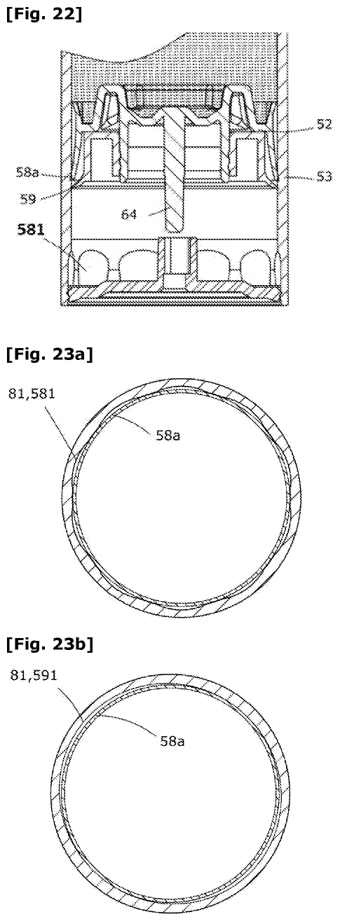

With reference to FIG. 22, in addition to the lower lip 58a, the piston 52 may comprise another lip 59 which thus improves the sealing between the piston 52 and the walls 53. The two lips 58a and 59 are oriented substantially in the same direction i.e. both towards the bottom of the product dispensing device i.e. both towards the inlet of the reservoir 6 through which the piston 52 has been inserted into the reservoir 6. The inlet of the reservoir 6 through which the piston 52 has been inserted into the reservoir 6 is, after insertion of the piston 52 into the reservoir 6, hidden by a cover 66 (this cover not being airtight, gastight or fluidtight against the fluid 7). This cover 66 may be arranged at the inlet of the reservoir 6 simultaneously with the insertion of the piston 52 into the reservoir 6. For this, the rod 64 may accommodate this cover 66 by passing through a hole (preferably triangular in shape) formed in the cover 66 so that the rod 64 is tightened in this hole and thus carries the cover 66.

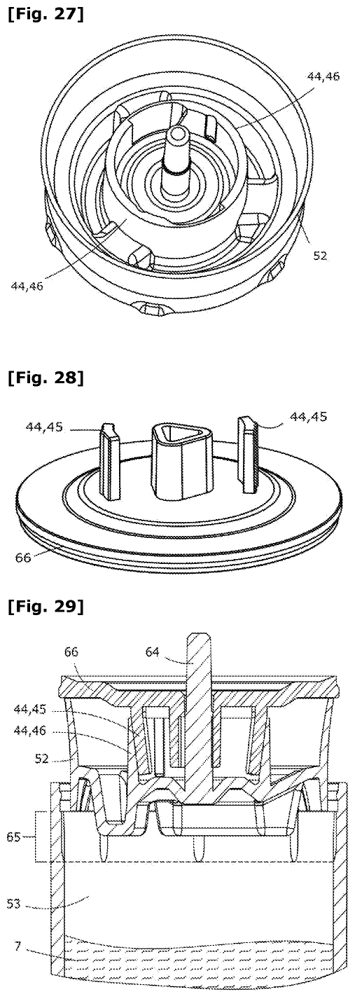

With reference to FIGS. 27 to 37, each variant of the device 101, 102, 103, 104 or 105 may comprise means 44 arranged so that, when the piston 52 has reached the sealing zone (i.e. the deep position of the piston 52) which is deeper than the zone 65 towards the pocket 2, it prevents or limits the return of the piston 52 into the zone 65 (i.e. the inlet position of the piston 52) of non-sealing of the piston 52 under a depression of the device of 0.4 or even 0.8 bar relative to atmospheric pressure, or at least limit the return of the piston 52 into the non-sealing zone 65 preferably to a height representing less than 30% of the height of the zone 65 (the height being measured along the axis of the reservoir) under a depression of 0.8 bar relative to atmospheric pressure.

Preferably, the device is arranged to prevent a return of the piston 52 into the non-sealing zone 65 under a depression of 0.8 bar relative to atmospheric pressure.

This means 44 may take several forms.

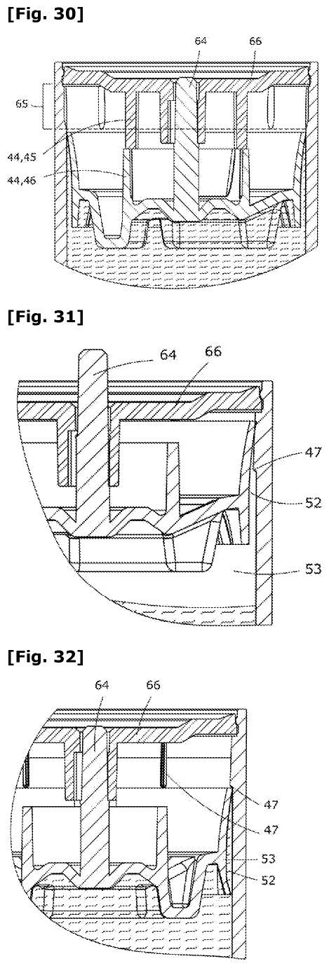

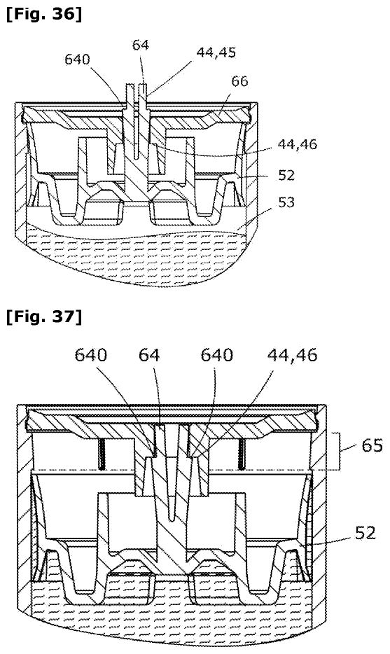

In a first variant with reference to FIGS. 27 to 30 or a third variant with reference to FIGS. 34 to 37, the means 44 comprise:
tabs 45 carried respectively either by the cover 66 (first variant with reference to FIGS. 27 to 30) or by the piston 52 (third variant with reference to FIGS. 34 to 37), and
walls 46 carried respectively either by the piston 52 (first variant with reference to FIGS. 27 to 30) or by the cover 66 (third variant with reference to FIGS. 34 to 37),
so that:
a) preferably, with reference to FIG. 29 or 36, after insertion of the piston 52 through the inlet of the reservoir 6 but before the piston 52 has reached the zone (called “deep”) of sealing (to the fluid 7 to be dispensed) which is deeper than the zone 65 towards the pocket 2, the tabs 45 and the walls 46 are concentric with respect to an axis parallel to the direction of insertion of the piston 52 into the reservoir 6, by being in contact and by deforming and/or pressing the tabs 45 and/or the walls 46 substantially perpendicularly to the axis parallel to the direction of insertion of the piston 52 into the reservoir 6, and
b) with reference to FIG. 30 or 37, after insertion of the piston 52 through the inlet of the reservoir 6 but after the piston 52 has reached the zone of sealing (to the fluid 7 to be dispensed) which is deeper than the zone 65 towards the pocket 2, the tabs 45 and the walls 46 face each other along an axis parallel to the direction of insertion of the piston 52 into the reservoir 6 so that they lock so as to prevent a return of the piston 52 into the zone 65 of non-sealing (to the fluid 7 to be dispensed). It is noted that, in the third variant of FIGS. 34 to 37, the rod 64 carries a surface 640, and that the tabs 45 and the walls 46 face each other on this surface 640 forming an angle and comprising a part parallel to the direction of insertion of the piston 52 into the reservoir 6 and a part perpendicular or oblique (but not parallel) to the direction of insertion of the piston 52 into the reservoir 6.

The features of a) are not mandatory, in particular when the cover 66 is positioned after the piston 52 has reached the sealing zone (for the fluid 7 to be dispensed) which is deeper than the zone 65.

The cover 66 is preferably held (for example by clipping or snapping) to the reservoir 6.

In a second variant, with reference to FIGS. 31 to 33, the means 44 comprise:
the lip 58a carried by the piston 52, and
extra thicknesses 47 formed on the walls 53.

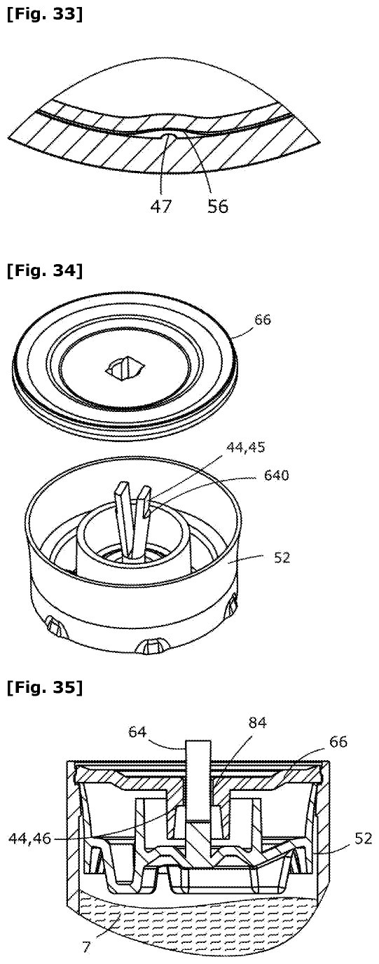

The extra thicknesses 47 are arranged:
a) preferably, with reference to FIGS. 32 and 33, after insertion of the piston 52 through the inlet of the reservoir 6 but before the piston 52 has reached the sealing zone (called “deep”) which is deeper than the zone 65 towards the pocket 2, to move the lip 58a away from the walls 53 so as to create an air passage 56 between the lip 58a and the walls 53, and
b) with reference to FIG. 34, after insertion of the piston 52 through the inlet of the reservoir 6 but after the piston 52 has reached the sealing zone (to the fluid 7 to be dispensed) which is deeper than the zone 65 towards the pocket 2, to form a stop for the lip 58a so that the lip 58a and the extra thicknesses 47 face each other along an axis parallel to the direction of insertion of the piston 52 into the reservoir 6 so that they lock so as to prevent a return of the piston 52 into the non-sealing zone 65 (to the fluid 7 to be dispensed).

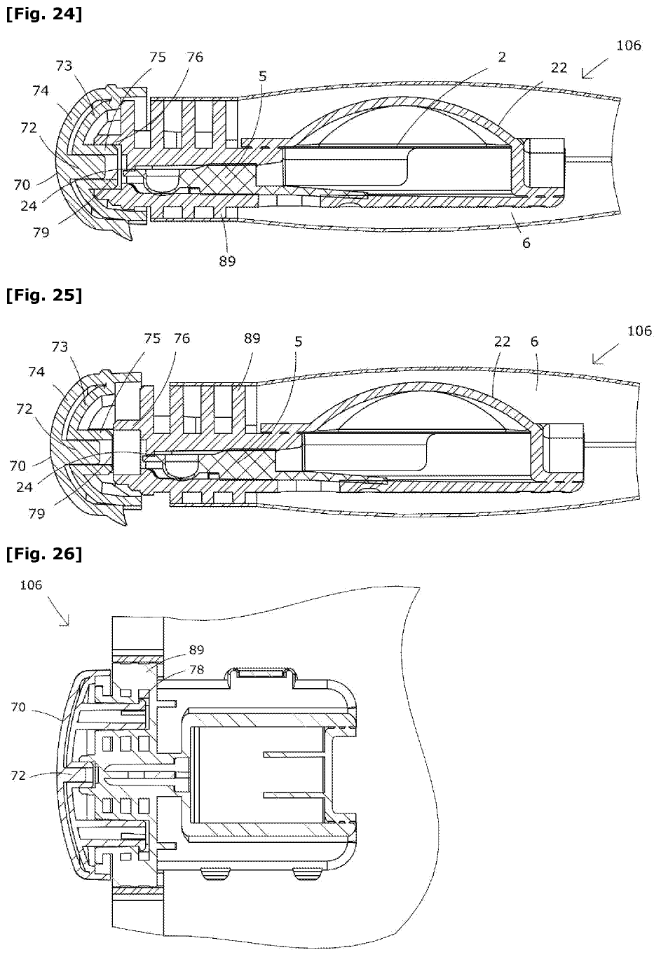

We will now describe, with reference to FIGS. 24 to 26, a sixth embodiment of device 106 according to the invention solely for their differences with respect to the first embodiment of device 101 and method of FIGS. 1 to 3.

In this embodiment, the device comprises a valve element 70 arranged to press against the end piece 89 surrounding and comprising the outlet 24 so as to block the outlet 24 in a gas-tight or non-gas-tight manner. The valve element 70 comprises a first part 74 provided with a nipple 72 movable, by means of a hinge 73, relative to a second part 73 fixed relative to the end piece 89 or at least capable of only translating relative to the end piece 89. The second part 73 is provided with a housing or a spout 75 oriented towards the outlet 24 of the end piece 89 arranged to respectively fit with a spout or a housing 76 of the end piece 89. Preferably, the housing is formed in the end piece 89 and the spout is formed on the part 73.

In a fixed version, the part 73 is fixed relative to the end piece 89, the device is arranged to allow gas (but not the product) from the pocket 2 to pass to the outside of the device via a non-sealed fitting of the spout 75 and the housing 76.

In a mobile version, the part 73 may translate relative to the end piece, the part 73 comprises two positions:
an open position allowing gas to pass from the pocket 2 to the outside of the device at the level of the fitting between the spout and the housing and, in a closed position, does not allow this, making the closed position completely watertight, the closed position being maintained by clips 78.

Of course, the invention is not limited to the examples which have just been described and many arrangements may be made to these examples without departing from the scope of the invention.

For example, for all of the embodiments previously described:
it is noted, with reference to FIG. 10, that all of the embodiments may do without the surface 15; in fact, the sensor 9 may be arranged to visualize and/or monitor the level of fluid 7 in the device according to the invention and monitor the progression of this level, and/or
the part 89 may be transparent to the radiation used by the sensor 9 (or the eye) and a surface 15 not transparent to the radiation used by the sensor 9 (or the eye), and a sensor (or the eye) which visualizes the surface 15 through the part 89, and/or
the part 89 may be transparent to the radiation used by the sensor 9 (or the eye), and a sensor (or the eye) which visualizes the level 30 of the fluid 7 through the part 89, and/or
the large section 141 is not necessarily constant and/or the small section 142 is not necessarily constant. For example, there may be a large section 141 that is a conical frustum tapering toward the small section 142 and/or a small section 142 that is a conical frustum increasing toward the large section 141. Similarly, the transition 143 does not necessarily include a step, but may be at an angle between the large section 141 and the small section 142 if at least one of these two sections is a conical frustum, or may be perfectly straight without discontinuity if the large section 141 and the small section 142 are both conical frustums with the same apex angle value, and/or
The dispensing valve 5 may be absent, in particular, the valve 5 may be replaced by a removable cover or removable shutter, and/or
the plug 23 may comprise a cover or a refill valve 50 (in particular if the device according to the invention forms a refill) or a cover perforator, and/or
the plug 23 may be screwed into the housing 13.

When the sensor is arranged to see the surface 15 or 30 through the opening 10 or the outlet 24, the radiation used by the sensor 9 has any frequency that may be in the infrared, visible, ultraviolet, ultrasound, X-rays, etc.

When the sensor is arranged to see the surface 15 or 30 through the part 89, the radiation used by the sensor 9 typically has a frequency greater than 16,000 Hz; preferably, the radiations used by the sensor 9 are typically ultrasounds (typically having a frequency between 16,000 Hertz and 10,000,000 Hertz) or X-rays (typically having a frequency between 10¹⁶ Hz and 10²⁰ Hz).

Of course, the different characteristics, forms, variants and embodiments of the invention may be associated with each other in various combinations to the extent that they are not incompatible or exclusive of each other. In particular, all the variants and embodiments described above may be combined with each other.

1. A product dispensing device, comprising:
an opening communicating with the outside of the device,
a plug,
a plug housing,
the device being arranged to, at least in the absence of the plug, evacuate fluid and/or gas through the plug housing from a pocket and/or a reservoir of fluid to the opening
characterized in that:
the plug housing comprises at least one main part,
the plug comprises at least one main part,
the main part of the plug housing being arranged to accommodate the main part of the plug, such that:
in a first insertion position of the plug into the plug housing from the opening, fluid and/or gas can escape from the plug housing through the opening along and/or around the plug, and
in a second insertion position of the plug into the plug housing from the opening, for which the plug is further pushed or moved into the plug housing than in the first insertion position, fluid and/or gas can no longer escape from the plug housing through the opening along and/or around the plug
the device comprising the pocket and a dispensing orifice connecting an interior volume of the pocket to an interior volume of a channel
the pocket being a deformable pocket having the interior volume arranged to contain the fluid.

2. Device according to claim 1, characterized in that the main part of the plug housing comprises a large section and a small section smaller than the large section, the large section being oriented towards the opening and the small section being oriented towards the pocket and/or the reservoir.

3. Device according to claim 1, characterized in that the main part of the plug comprises a lateral cavity arranged for a passage of fluid and/or gas along and/or around the plug in the first insertion position of the plug and for a hermetic storage of fluid and/or gas in the second insertion position of the plug.

4. Device according to claim 3, characterized in that the lateral cavity is defined between two sealing rings carried by the main part of the plug.

5. Device according to claim 1, characterized in that:
the plug housing comprises following two communicating parts:
its main part oriented towards the opening
a thinned part oriented towards the pocket and/or the reservoir, the thinned part having a smaller section than the main part of the plug housing,
the plug comprises following two joined parts:
its main part
a finger, the finger having a smaller section than the main part of the plug
the finger of the plug being arranged to be inserted into the thinned part of the plug housing, so that, at least in the first insertion position of the plug, the finger expels fluid and/or gas from the thinned part towards the opening.

6. Device according to claim 1, characterized in that:
the opening is an outlet from the device,
the main part of the plug carries a dispensing valve and/or the main part of the plug housing houses a dispensing valve, which in an open state, allows a passage of fluid from the inside of the pocket and/or reservoir to the outlet, and, in a closed state, does not allow a passage of fluid from the inside of the pocket and/or reservoir to the outlet.

7. Device according to claim 1, characterized in that the plug housing comprises clipping or snap-fastening means arranged to hold the plug in its first insertion position.

8. Device according to claim 1, characterized in that it comprises the pocket and the reservoir, and that it further comprises a feed orifice which connects the interior volume of the pocket with the interior volume of the reservoir, and a feed valve which in an open state, allows a passage of fluid from the reservoir to the interior of the pocket, and, in a closed state, does not allow a passage of fluid from the reservoir to the interior of the pocket.

9. A method of filling a device according to claim 1, in which:
the pocket and/or the reservoir are filled with fluid while the plug is inserted in the first insertion position in the plug housing or is not inserted at all in the plug housing, and:
fluid and/or gas are caused to rise from the pocket or reservoir towards the opening, preferably by pressing on the pocket and/or the reservoir so as to reduce the volume, and/or,
the plug is pushed or moved in the plug housing so as to move it from its first insertion position to its second insertion position.

10. Method according to claim 9, characterized in that:
fluid and/or gas are caused to rise from the pocket or reservoir towards the opening,
then a level of fluid or of the plug in the plug housing is detected by a sensor, preferably optical or ultrasonic, above a predefined threshold,
then the plug is pushed or moved into the plug housing so as to move it from the first insertion position to the second insertion position.

11. Method according to claim 9, characterized in that:
fluid and/or gas are caused to rise from the pocket or reservoir towards the opening, preferably by pressing on the pocket and/or reservoir so as to reduce its volume, preferably while the plug is not inserted at all into the plug housing,
then a fluid level in the plug housing is detected by a sensor, preferably optical or ultrasonic, above a predefined threshold, preferably while the plug is not inserted at all into the plug housing,
then the plug is pushed or moved into the plug housing so as to move it from the outside of the housing to the first insertion position so that the volume of gas in the housing is replaced by the volume of the plug and/or fluid in the housing and escapes from the plug housing through the opening along and/or around the plug,
then the plug is pushed or moved in the plug housing so as to move it from the first insertion position to the second insertion position.

12. Method according to claim 9, characterized in that:
fluid and/or gas are caused to rise from the pocket or reservoir towards the opening, preferably by pressing on the pocket and/or reservoir so as to reduce its volume and, while the plug is inserted in the first insertion position in the plug housing, so that the volume of gas in the housing is replaced by the volume of the plug and/or fluid in the housing and escapes from the plug housing through the opening along and/or around the plug,
then a level of the plug is detected by a sensor, preferably optical or ultrasonic, above a predefined threshold, while the plug is inserted in the first insertion position in the plug housing,
then the plug is pushed or moved in the plug housing so as to move it from the first insertion position to the second insertion position.
